(19) United States
(12) Patent Application Publication
(10) Pub. No.: US 2026/0307765 A1
(43) Pub. Date: Oct. 8, 2026

(54) SOLAR PANEL ARRANGEMENT WITH TELESCOPING FRAME FOR A SAILING VESSEL

(71) Applicants: Cameron Michael Burdgick, Ann Arbor, MI (US); Steven Sebastian Burdgick, Schenectady, NY (US)

(72) Inventors: Cameron Michael Burdgick, Ann Arbor, MI (US); Steven Sebastian Burdgick, Schenectady, NY (US)

(21) Appl. No.: 19/079,116

(22) Filed: Apr. 7, 2025

(51) Int. Cl. B63B 35/44; H02S 20/30; H02S 30/20

(52) U.S. Cl. CPC B63B 35/44; H02S 20/30; H02S 30/20; B63B 2035/4453

(57) ABSTRACT

This invention relates to the method of configuring a solar panel system on the foredeck of a sailing vessel using a telescoping frame for permanent or temporary attachment to the vessel. The invention relates to significantly improved solar energy capture by substantially increasing energy absorption area compared to existing designs for more efficient recharging of batteries. The solar panel arrangement uses a telescoping base for quick storage and deployment of the photovoltaic panels on the foredeck while underway or static. The telescoping frame can be adjusted to a multitude of deck geometries with modular design for various panel lengths and using adjustable feet. Base feet can be permanent for stability while sailing or motoring. The telescoping system can use folding, sliding, or quick attach solar panels. Application of this invention can also be configured on motor vehicles, travel trailers or similar.

### FIELD OF THE INVENTION

The subject matter disclosed herein relates to a solar panel, or photovoltaic (PV) panel, configuration using a telescoping base for use on a sailing or motor vessel. More particularly, aspects of the invention include various configurations related to the attachment of PV panels to the telescoping base, such as folding, sliding, or quick attachment, and adjustability of the same.

The subject matter disclosed herein relates to a solar panel, or photovoltaic (PV) panel, configuration using a telescoping base for use on a sailing or motor vessel. More particularly, aspects of the invention include various configurations related to the attachment of PV panels to the telescoping base, such as folding, sliding, or quick attachment, and adjustability of the same.

### BACKGROUND OF THE INVENTION

Sailing vessels typically require electricity in some form to charge a battery bank. The battery bank on sailing vessels is used to run onboard accessories, electronics for navigation, refrigerator, freezer and similar items. Modern sailing vessels are also shifting to hybrid propulsion systems that combine an electric motor with a diesel combustion engine, instead of a diesel only system. In addition, fully electric propulsion motors have been introduced for sailing vessels, turning a propeller or jet pump to replace traditional diesel combustion engines. While sailing in remote locations, whether anchored or on a mooring ball, there is no shore power. During these situations the only methods for energy creation to charge the onboard batteries is to turn on the engine, turn on an onboard generator if it exists, use an installed wind power generator if it exists, or use solar panels. Furthermore, similar situations exist on motorized vessels on large bodies of water. Most water vessels use a battery bank to supply direct current to appliances, refrigeration, pumps, and similar items on the vessel, without the use of a generator.

Each of these methods of energy creation has distinct benefits, drawbacks and challenges. Running the main engine or using an onboard generator is costly, noisy, creates heat, and requires humans to be present for operation and monitoring. In addition, internal combustion engines, whether the main engine or a generator, burn fossil fuels to operate. Both the production of such fuels and engine exhaust gas from burning such fuels are harmful to the environment. While fossil fuels have a very high energy density, their usage requires resupply at given intervals and stocking of fuel onboard, adding to the weight of the vessel.

Using wind generation requires the purchase and installation of fixed base equipment. Additionally, wind generation using small blade sizes results in unwanted noise and very limited power output. The increasing efficiency and affordability of solar panels have made solar power a popular choice for sailboats, despite limitations. Solar power can be limited by location, permanent or non-permanent installation, panel orientation relative to sun position, and most significantly, limited available space on a sailing vessel for large area solar panel arrangements. These limitations have led to the present invention. For example, completely covering the foredeck or middeck of a sailboat is prohibitive. Much of the walkable area on a boat is needed to tend to items such as anchors, lines, forward hatches, or sails. Solar panels that can have the ability to be walked upon are limited in efficiency and cost prohibitive.

It is generally known that solar energy can be converted into electrical energy by means of solar panels. Photovoltaic panels or modules are routinely used for capturing this energy and are known in multifarious designs and therefore does not call for further explanation. Lightweight or flexible photovoltaic panels are further known, in which the individual photovoltaic elements are flexible and often arranged on a flexible flat or curved structure. Flexible, thin, solar panel design and construction is also essentially known and therefore does not require further exposition.

Photovoltaic solar panels absorb energy from sunlight to facilitate generation of electricity, in this case for storing that energy in a bank of batteries on a sailing vessel. There have been different approaches to using solar panels on a sailing vessel. Fixed, permanent, equipment has very limited locations for installation on a sailboat due to the amount of rigging (lines, ropes) and open deck space that is needed for unimpeded movement about the vessel. Typical “permanent” placement for solar panels is on top of the bimini. A sailing vessel bimini typically consists of a canvas covering over the cockpit area that is attached to framework mounted to the topdeck (deck) of the sailing vessel. A general application of solar panels in the form of a bimini can be seen in U.S. Pat. No. 11,764,726 Wynn. However, in this application it is not applied to a sailing vessel for limitations exist within the land-based design addressed in the patent. These bimini mounted panels may be flexible or rigid. An alternative permanent mounting location is the small area around the base of the mast. These panels are typically flexible because this deck area is typically curved. Flexible panels are less efficient and more expensive than rigid panels. Panels mounted in this location must also be walkable, adding further costs for increased strength. A third placement area is typically a framework extension behind, or aft, of the cockpit area. This approach uses a semi-permanent mounting of limited size solar panels, usually on a pedestal connected to the vessel deck. These deck panels may be flexible or rigid.

Another semi-permanent mounting location is the aft part of the vertically extending mast. Mast mounting requires attachment elements for the rail or slot on the mast. These elements may not be universal for all masts and may require considerable time to attach to masts for deployment. Furthermore, mast-mounted solar arrays can be susceptible to high winds due to limited support, and they cannot be used while sailing because they are located where the main sail is raised. Lastly, non-permanent solar panels can be stacked vertically with limited area and high susceptibility to wind damage due to small single line attachment. The use of such arrangements of solar panels is limited in usage as the vessel must not be under sail, or sailing.

One of the major drawbacks of solar panel energy generation on sailing vessels is the limited size of the panels, therefore, the time required to accumulate significant energy storage by way of the onboard batteries. As energy demands on a sailboat increase with the advent of electric propulsion, increased navigation equipment and hand-held device recharging needs, more energy replenishment is required. Many sailors do not have access to unlimited shore power and require other generation methods. Most of the current solar panel usage on sailing vessels requires considerable time in the sun to recharge the batteries, due to either limited solar panel area or limited power output by using less efficient flexible panels. This limitation in charging ability necessitates innovation to achieve as much solar panel area as possible within constraints of the vessel, leading to the invention described within. This also solves the issue with adding battery capacity and weight to the vessel.

The problem with many solar panel arrays and installations for mobile applications requiring remote charging of batteries is the ability to easily and quickly setup the solar panel array, and to stow the array for transportation or non-use. Such mobile applications include sailing or motor vessels, travel trailers, cars, trucks or other applications.

### SUMMARY OF THE INVENTION

The invention is not limited to a sailing vessel but can be applied to such situations as an on-water motor vessel, a travel trailer, an automobile top, or similar. A sailing vessel is used to describe the preferred embodiment of the telescoping solar panel arrangement.

The invention provides novel use of commercially available solar panels, a telescoping frame support structure for large area solar panel deployment, and adjustable mounting features requiring no physical changes to the sailing vessel. This invention can be used with rigid or flexible panels, or a combination of both. Compared to rigid panels, flexible panels are lighter but less efficient and more expensive.

It is intended for both static or moving state in which the forward sail, the jib, is in use for the fully extended telescoping solar panel arrangement. The invention addresses several of the main drawbacks to current solar panel usage on a sailboat, particularly the limited deck space available. The invention allows for deployment during sailing, or quick on-deck stowage of the arrangement minimizes time needed to secure the arrangement should the cleared foredeck quickly be needed. The stowed configuration can be semi-permanently or permanently mounted at its base location forward of the mast, on the vessel foredeck. This invention and its various embodiments address the manual labor required to extend or telescope the panel arrangement, or to attach individual panels in a further embodiment.

Furthermore, although this design may compete for the same space as other potential solar panel usage on a sailboat, this invention allows for convenient and full usage of the foredeck area. Alternative permanent panels that could occupy the same space are small and flexible, and therefore inefficient and expensive. Alternative temporary or semi-permanent panel configurations either cannot be used while sailing; lack support for sturdy attachment to the deck and for large panels; or are difficult to deploy and collapse quickly.

According to the invention the solar panels are generally placed with the long transverse sides butted up against one another and oriented parallel to the transverse direction of the sailboat, which is mutually perpendicular to the forward to aft centerline of the sailboat. The solar panel flat surface is generally parallel to the horizon or topdeck of the sailing vessel. The panels are generally rectangular with a width of 12 to 24 inches and a length of 24 to 96 inches, for example. The modularity of the attachment and base allow for various panel sizes to be used to cover the foredeck of the sailboat as needed. The solar array can consist of any number of panels within the geometric constraints of each sailing vessel.

The solar panels are preferably attached to the telescoping frame by way of a plurality of overhanging clips or hold-downs on the front side of the panel. The overhanging clip being substantially mounted to each telescoping segment. The aft portion of each solar panel would be held preferably by a pin mechanism that is mounted to each telescoping frame segment. The pin being aligned parallel to the transverse direction of the solar panel and engaging in an axially projecting member from the back side of the solar panel. The pin attachment would be spring loaded thereby allowing the user to pull back the pin during assembly and release it to engage in the solar panel projection thereby locking each panel in place on the telescoping frame. Once the frame is fully extended in the axial direction the solar panels would then be temporarily attached. For stowage of the solar panel arrangement the solar panels would be removed from the semi-permanent attachment points, bundled together with straps or into a bag, and stowed either on the vessel topside or within the sailing vessel below deck cabin.

In another embodiment the attachment of the solar panels may be done with “t-slot” connections at either the forward, aft, or both transverse sides of the solar panel to the frame. Screws or cam-locks can also be used at the forward, aft, or both transverse sides of the solar panel to the frame. Generally, the preferred method would not have any feature that is not semi-permanently affixed to either the solar panel or frame so the attachment feature cannot be lost or misplaced during use.

Each solar panel is preferably permanently attached to a solar panel frame structure which ultimately attaches temporarily to the full telescoping base frame structure. In one embodiment the solar panel frame structure would consist of an aluminum frame using primarily square tubing. The aluminum frame would be constructed out of square tubing of gauge 19 to 14 wall with a tubing width of 0.625 to 1.25 inch square. Frame to have welded joints at intersections. In another embodiment the joints could be pinned or screwed together with corner brackets accepting the square tubing. Finally, the tubing could be made from thin-walled stainless steel tubing or composite material such as carbon fiber to reduce weight or increase structural stiffness. Flexible or rigid solar panels to be affixed to frame upper surface by a semi-permanent or permanent attachment. Solar panel attachment can be done using temporary zip ties, screw and washer, or similar. Permanent attachment of flexible panels to a frame structure for each solar panel could include permanent high strength adhesive. Solar panels may also be made as a unified assembly that includes a subframe structure and solar panel as part of a complete purchased part.

The base telescoping frame structure consists of rectangular or round tubing with each axial projecting section sliding within the adjacent nested section to allow for both a fully extended support structure and a fully compact system for storage. The axial projection direction for the telescoping frame is generally in line with the forward to aft centerline of the sailing vessel. The preferred embodiment of the telescoping sections would be a thin-walled aluminum rectangular section that is generally 0.75 to 1.25 inch wide in the horizontal direction for the smallest section, to 1.25 to 2.5 inches in the vertical direction, for the smallest section. Each adjacent and encompassing section would be larger by at a least 2 times the wall thickness to allow for each section to nest within the other adjacent section. During full extension of each frame section that is nested within the adjacent frame section, there would preferably be a spring-loaded pin attachment to lock each section in the fully axially extended condition. Solar panels would then be attached to each frame section adjacent to one another along each transverse side. Each frame section would have a mutually perpendicular section attached to the axial nested sections. The perpendicular sections give the base structure transverse stiffness and self-alignment between nested sections. The telescoping frame structure would consist of at least two nested sections to allow for a minimum of two solar panel telescoping arrangement.

The base telescoping frame structure, in the preferred embodiment, would have vertical downward projecting members at each of the four outermost corners. The vertical projections would use male-female fits between nested square or round tubing for vertical adjustment in height. These mounting projections would use a spring-loaded pin for adjustment in the vertical direction to allow for various sailing vessel foredeck configurations. In one embodiment the two aft mounting projections would have base feet that mount to the foredeck by permanent or semi-permanent means. The preferred embodiment would have a swivel or articulate joint between the vertically downward projecting members and the base foot, to allow for various foredeck orientations that are completely horizontal and flat, or curved. The two forward vertically downward mounting projections would also have attached base feet that would preferably have swivel connections between projections and feet. The forward feet may be temporarily or permanently mounted to the foredeck. In another embodiment the aft base feet, or the aft and forward base feet may be permanently glued or adhered to the deck. Additionally, the forward frame section may be temporarily held in the vertical direction by a strap across the frame and attached to cleats on the foredeck to limit movement while frame is fully extended.

In another embodiment the solar panels may have a pinned connection to each telescoping frame member. There would be at least two pin connections at the front side or aft side of each panel to its corresponding frame member. The opposite transverse side of each panel would have at least two pinned connections to the adjacent panel, allowing for a pivoting connection between panels. The telescoping frame structure would consist of at least one set of folding panels but may have several to match the number of telescoping frame sections. Each set of folding panels would connect to at least 2 sets of base frame sliding assemblies. Once the system is collapsed in the axial direction for storage the solar panels would be in the vertical orientation and abutted one against another in the folded configuration. In a further embodiment the forward frame sections would have the pin attachment oppressively taller than the downstream frame sections. Offsetting the pivot points on the frame structures or adjusting the relative width of adjacent panels in the axial direction, allows for the collapsed system to have the solar panels fold one on top of the other in a horizontally stacked arrangement, the panels being generally in the horizontal plane. The embodiment with a horizontally stacked solar panel arrangement allows for a compact panel arrangement where the panels can remain stored on the foredeck and not hinder movement of persons or sails while under-way or static. For the folding solar panel configuration, the compact folded panels could then be strapped together for temporary stowage of the system.

In a further embodiment the telescoping solar panel arrangement can be used in several other use areas. The invention is directly applicable to motorized boats, car tops, travel trailer tops, or similar, for auxiliary charging of batteries. The main benefit in these adjacent use areas is the modular design and ability for quick deployment of large solar panel surface area which can be conveniently compacted for storage.

Distribution of the converted solar energy would be done through energy transmission wires or cables that are connected to common solar panel connection points. Transmission wires then continue through each adjacent panel connection from the forward first panel to the aft last panel in the array. The final energy transmission wire would then lead to a solar charge controller and finally to the main battery storage bank. The electrical connection can be to a wire strung across the deck, through a port access, or ideally to a fixed interconnection point installed on the foredeck of the sailing vessel. The electrical connections to the sailboat battery bank, and to the individual photovoltaic solar panels are not shown, as the design of such electrical connections are known to those knowledgeable in the field or practice of solar panel system design and therefore is not specifically addressed as a novel design feature to the invention.

In a further embodiment the invention has axially slotted side rails for each subpanel frame. Engaging each axially oriented panel slot is a “T-shaped” member that substantially locates one solar panel frame to the adjacent frame. Combining substructure panel frames in the axial direction provides for a structure that can be extended to provide full exposure or collapsed axially for storage. The front part of each panel frame would have connected “T” member engagement thereby providing both vertical and transverse support to the overall structure. The sliding panel arrangement would use the same vertical leg members as the quick attach and folding solar panel inventions.

### BRIEF DESCRIPTION OF DRAWINGS

These and other features of this invention will be more readily understood from the following detailed description of the various aspects of the invention taken in conjunction with the accompanying drawings that depict various embodiments of the invention, in which:

FIG. 1 shows a three-dimensional perspective view of the preferred embodiment of a sailing vessel telescoping solar panel array according to various embodiments of the invention.

FIG. 2 shows a three-dimensional view of an embodiment of the solar panels and frame structure in the extended configuration from FIG. 1.

FIG. 3a shows a three-dimensional view of an embodiment of the solar panel frame structure in the extended configuration from FIG. 2.

FIG. 3b shows a three-dimensional view of an embodiment of the solar panel frame structure in the compacted, or stowed, configuration from FIG. 3a.

FIG. 4 shows a three-dimensional view of the adjustable base mounting leg from FIG. 3.

FIG. 5 shows a three-dimensional view of an embodiment of the solar panel and supporting frame structure from FIG. 1.

FIG. 6a shows a three-dimensional view of the solar panel system in the extended configuration.

FIG. 6b shows a three-dimensional breakaway view of the forward and aft attachment feature for the removable panel embodiment as depicted in FIG. 3a with the locking pin in the unlocked position.

FIG. 6c shows a three-dimensional breakaway view of the forward aft attachment feature for the removable panel embodiment as depicted in FIG. 3a with the locking pin in the locked position:

FIG. 7 shows a left side two-dimensional breakaway view of the forward and aft attachment feature for the removable panel embodiment as depicted in FIG. 1 with encapsulating projection and locking pin assembly.

FIG. 8a shows a three-dimensional view of the fully extended folding solar panel arrangement.

FIG. 8b shows a three-dimensional view of the partially collapsed folding solar panel arrangement as depicted in FIG. 8a. Base feet projections are removed for clarity.

FIG. 9 shows a left side two-dimensional view showing the folding panel embodiment of the telescoping frame configuration as depicted in FIG. 8a, in the stowed condition.

FIG. 10a shows a three-dimensional view of the fully extended sliding solar panel arrangement. Base feet projections are removed for clarity.

FIG. 10b shows a three-dimensional view of the collapsed folding solar panel arrangement as depicted in FIG. 10a. Base feet projections are removed for clarity.

FIG. 11 shows a three-dimensional breakaway view of the panel sliding rail and sliding insert feature in the solar panel arrangement as depicted in FIG. 10a.

### DETAILED DESCRIPTION OF THE INVENTION

It is noted that the drawings of the invention are not necessarily to scale. The drawings are intended to depict only typical aspects of the invention and therefore should not be considered as limiting the scope of the invention. In the drawings like numbering represents like elements between the drawings.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back”, or “forward” and “aft”, are not intended to be limiting and are intended to be interchangeable where appropriate.

On a sailing or motor vessel the term “bow” or “forward”, traditionally refers to the “front” of the vessel. Additionally, the terms “aft”, “rear” or “stern” refers to the “back” of the boat, sometimes called the “cockpit” area. The “cockpit” area typically contains the steering system and/or navigations system. It is further understood that the terms “left” and “right” are not intended to be limiting and are intended to be interchangeable where appropriate. On a boat traditionally the term “port” refers to the “left” side of the boat while looking forward towards the front of the boat. Finally, the term “starboard” traditionally refers to the “right” side of the boat while looking forwards towards the front of the boat. An additional term traditionally used in sailing vessels for aiding detailed descriptions and understanding thereof. The term “foredeck” refers to the upward facing and horizontal surface forward of the mast.

The imaginary line between the bow and stern of the vessel is considered the longitudinal centerline. The vertical upward projecting mast is mutually perpendicular to the longitudinal centerline and traverse, port-to-starboard, centerline of the vessel's upper deck. The upper deck is the top upward facing portion of the vessel. Specifically, a sailing vessel has a horizontal boom that is attached near the bottom, or foot, of the mast and becomes the retainment of the sail when sailing.

The present invention will now be described more fully with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

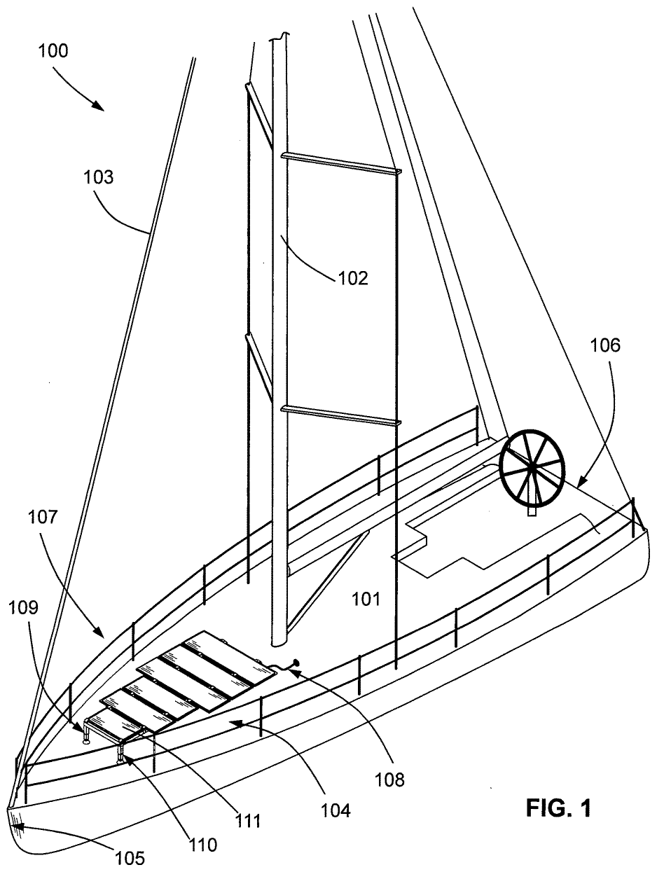

Referring now to the drawings which form the embodiments of the telescoping solar panel arrangement for large area capture, in accordance with the present invention as represented in FIG. 1. Perspective view FIG. 1 shows an arrangement 107 of a plurality of photovoltaic solar panels 111 that are mutually parallel and generally transverse to the sailing vessel 101 forward 105 to aft 106 centerline. The solar panel sailing system 100 is arranged on the foredeck 104 of the sailing vessel 101. Furthermore, the solar panel arrangement 107 is permanently or semi-permanently attached to the sailing vessel on the foredeck 104. The solar panel arrangement 107 consists of a telescoping frame for mounting to the sailing vessel foredeck 104. Generally, the solar arrangement 107 would be placed generally between the sailing vessel 101 forestay 103 and the vertical mast 102. The forward leg mounts 109 and 110 support the forward portion of telescoping arrangement 107. Electrical wire 108, used for transferring the photovoltaic energy to the solar charge controller, and ultimately the battery bank, is connected to each panel of arrangement 107. Electrical connections to panels, and connections to on-board equipment are well known in the industry and do not require further explanation as novelty is not present. Wire 108 would connect to the end of solar panel arrangement 107 then terminate at a solar charge controller by way of extension on deck 104 or through a port hole.

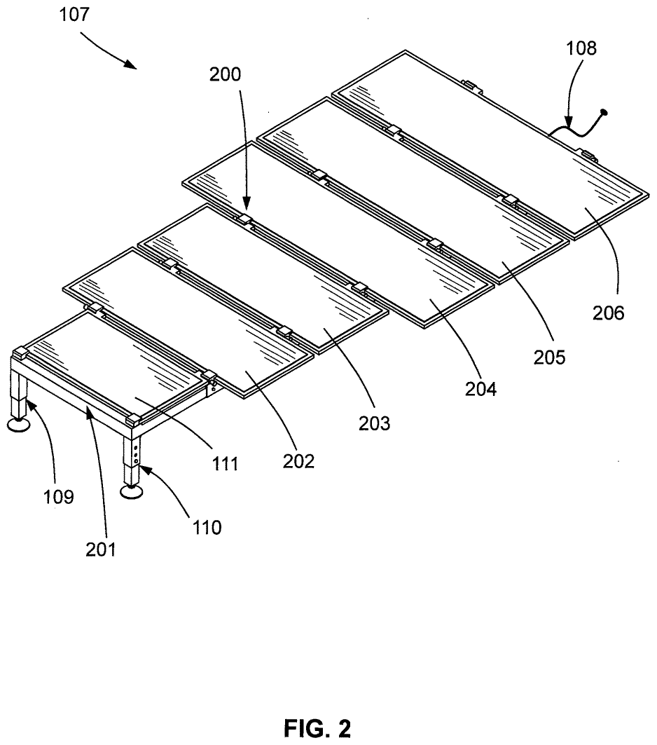

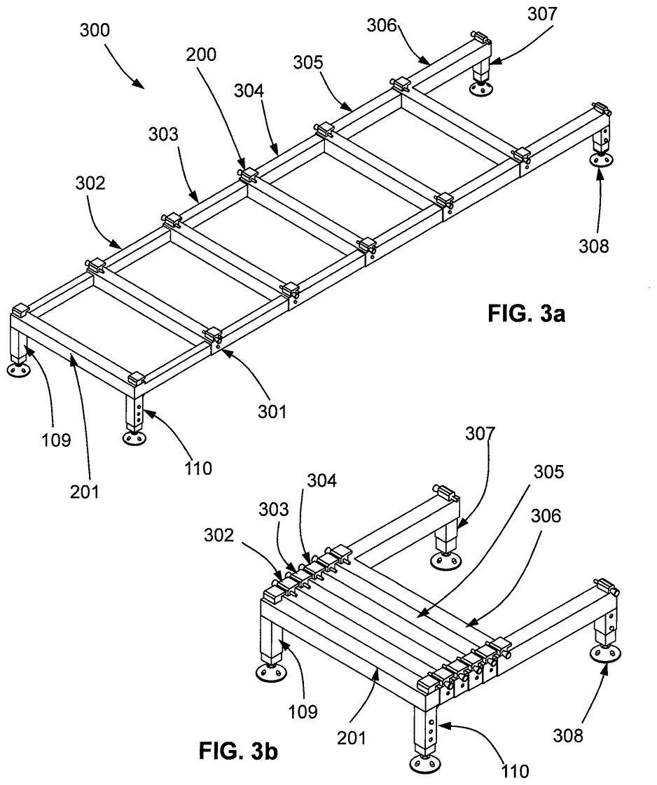

Referring to FIG. 2, is a three-dimensional view of the solar panel horizontal array 107 consisting of solar panels 111, and 202 through 206 substantially connected to telescoping frame 300 FIG. 3. Frame structure 300 has vertically downward projection extensions 109 and 110, showing on the forward end, used for vertical adjustability of the frame structure 300. Solar panels are attached temporarily to telescoping frame 300 by a plurality of hold-down features 200 on each base sliding substructure. Solar panel arrangement 107 has the solar panels 111 and 202 through 206 generally abutted one to another in the axial forward 105 to aft 106 direction and panels 111 and 202 through 206 are generally centered in the transverse direction, left-to-right, corresponding to the axial centerline of the sailing vessel 101.

Shown in FIG. 3a is a three-dimensional detailed view of telescoping frame 300, as part of solar panel arrangement 107. Solar panel elements for 111 and 202 through 206 are removed for clarity. Telescoping frame 300 consists of a plurality of nesting sections 201 and 302 through 306 forming the axial extendable and axially collapsable structure. Nesting subframes 201 and 302 through 306 are preferably tubular thin-walled structures fabricated using welding or similar methods. Substructure subframes 201 and 302 through 306 can be rectangular or circular tubing with each section being slightly smaller than the adjacent subframe, allowing for sliding capability to extend and collapse the telescoping structure 300. Spring pin connections 301 would generally be used between subframe axial sliding connection points. These connections between subframe members 201, and 302 through 306 have left and right nested tubing for axial sliding. Vertically downward projections 109, 110, 307 and 308 are used to adjust the frame 300 attitude to allow for various foredeck 104 configurations. In general, the plurality of vertical adjusting leg projections 109, 110, 307 and 308 would be placed in the four remote corners of the telescoping frame structure 300. Aft frame leg projections 307 and 308 would typically be permanently or semi-permanently mounted to the foredeck 104. Forward leg projections 109 and 110 would be vertically adjustable but may only rest on foredeck 104 instead of permanent attachment. Temporary attachment of forward legs 109 and 110 may be done using various hold-down mechanisms commercially available.

Shown in FIG. 3b, is a three-dimensional view showing the embodiment of the invention in the collapsed or stowed state related to FIG. 3a. Subframes 201 and 302 through 306 have the plurality of spring pins 301 released and each subframe 201 and 302 through 306 is slid axially, in the forward 105 to aft 106 direction, to collapse the frame structure 300. Once frame structure 300 is collapsed the front leg bases 109 and 110 can be semi-permanently affixed to the foredeck 104. In another embodiment the frame structure 300 can have the collapsed structure temporarily held down to foredeck 104 using lines or quick release mechanisms that are commercially available (not shown).

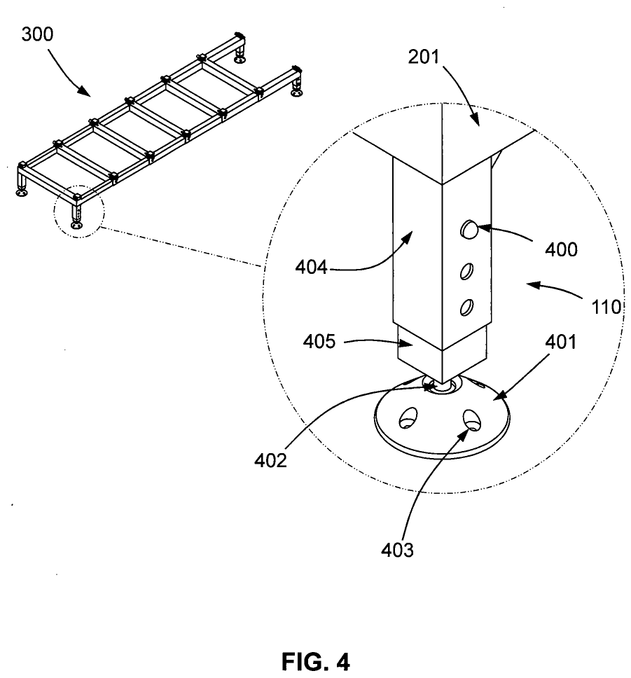

Referring to FIG. 4, an exploded view of vertically adjustable base leg 110 consisting of attached base foot 401 as related to frame assembly 300. Base foot 401 is attached to vertical male member 405 through a swivel attachment point 402. The adjustable vertical male member 405 is encapsulated within vertical female member 404. Vertical adjusting leg member 405 is locked into position with locking spring pin mechanism 400. Vertical leg member 404 would be permanently connected to subframe member 201, generally by welding. A plurality of holes 403 would be used in base foot 401. Adjustment leg member 110 is generally duplicated at leg positions 109, 307 and 308.

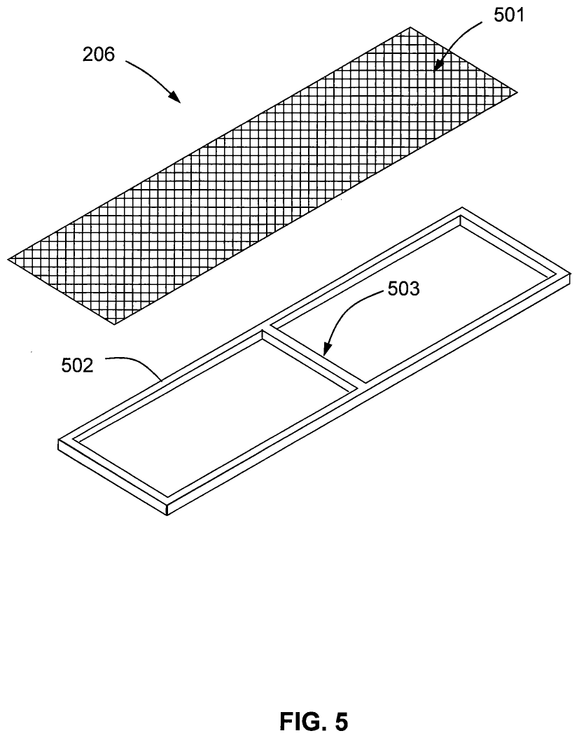

Referring to FIG. 5, the exploded view schematic of one solar panel element 206 is shown with combined parts shown separately for clarity of the combined assembly as shown in FIG. 1. Flexible or rigid solar panel 501 to be attached permanently or semi-permanently to lightweight frame 502. Frame 502 would generally have at least one cross member 503 having mutually affixed ends to frame 502. In one embodiment an aluminum rectangular frame 502 would be used. The aluminum frame 502 would be constructed out of square tubing of gauge 19 to 14 wall and a tubing size of 0.625 to 1.25 inch square. Frame 502 to have welded joints at intersections. In another embodiment, the joints could be pinned or screwed together with corner brackets accepting the square tubing. Finally, the tubing could be made from composite material, or similar lightweight and high strength material. Flexible or rigid solar panels 501 to be affixed to frame 502 upper facing surfaces by a semi-permanent or permanent attachment. Solar panel 501 attachment can be done using temporary zip ties, screw and washer, or similar. The permanent attachment of flexible panels 501 could include permanent high strength adhesive. In other embodiments, the solar panel 501 and frame 502 may be an inseparable purchased assembly.

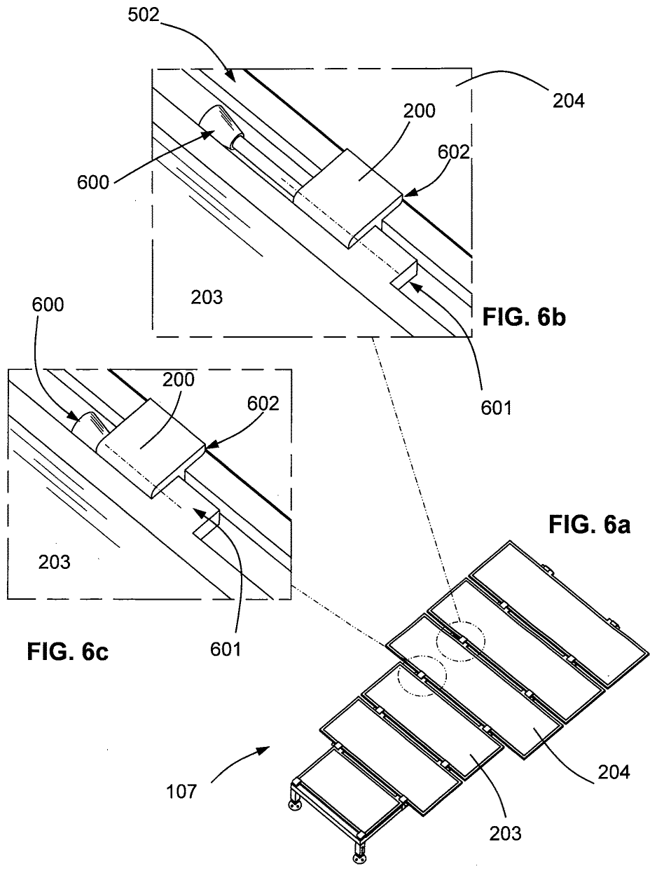

Referring to FIG. 6a, showing the three-dimensional fully extended solar panel arrangement 107. FIG. 6b details the exploded view schematic of one solar panel connection feature 200 as depicted in FIG. 6a. Hold down element 200 is permanently attached to subframe members 201 and 302 through 306 at each corner as shown. Hold down feature 200 has axially projecting overhang 602 that contains the forward edge of each respective solar panel frame 502. Locking spring pin 600 is shown in the unlocked position for assembly of the forward part of the panel frame. Referring to FIG. 6c, showing a similar detail exploded view schematic of one solar panel connection feature 200 as depicted in FIG. 6a. In this view, locking spring pin 600 is shown in the locked position with spring-loaded pin 600 transversely projected through solar panel frame projection tab 601. The spring-loaded locking pin mechanism holds each solar panel 111, and 202 through 206 with at least two aft pinned locations per panel.

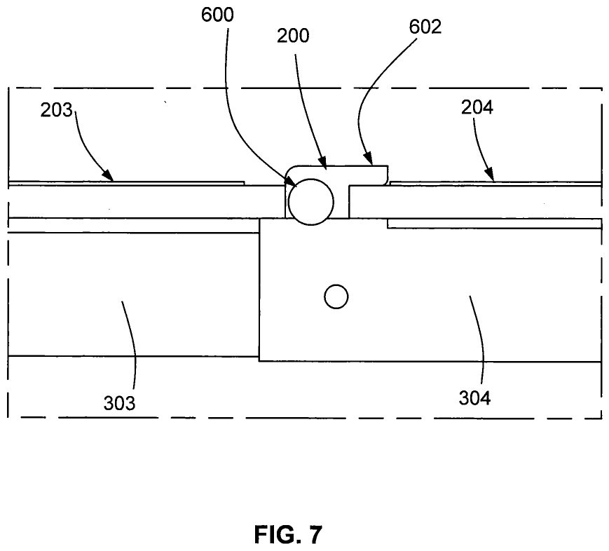

Referring to FIG. 7, a two-dimensional cutaway view of holding element 200 further detailing axial hold down projection 602 as it projects axially aftward over solar panel 204 frame 502. Additionally, locking pin 600 is horizontally oriented to lock into panel 203 frame 502 projection 601.

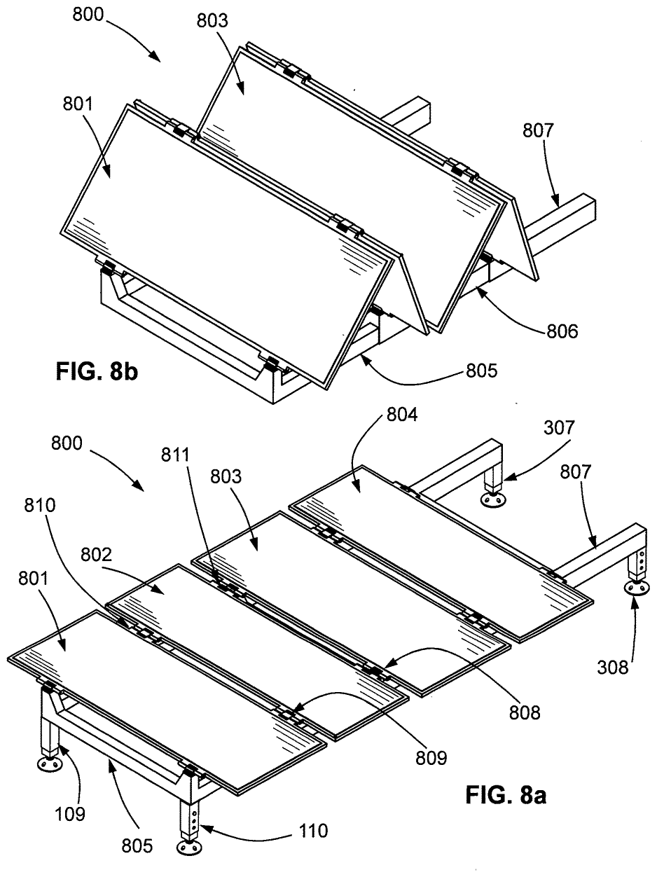

In another embodiment of the invention, referring to FIG. 8a, a folding solar panel arrangement consisting of hinged panel attachment points 808 and 811 between panels 801 through 804 with at least two hinge members per solar panel abutment. Specifically for example two hinge elements 809 and 810 would be used between the first two abutted panels 801 and 802. Hinge element 808 and 811 would be used between subframe member 806 and solar panels 802 and 803 respectively. Folding solar panel arrangement 800 uses the same base leg mounting elements 109, 110, 307 and 308 from telescoping frame invention 300. Folding arrangement 800 is shown in the fully extended configuration.

Referring to FIG. 8b, showing a three-dimensional partially collapsed frame structure 805 through 807. Furthermore, solar panels 801 and 802, for example, represent the upward vertical movement of the hinged connections elements 809 and 810. Legs 109, 110, 307 and 308 are removed for clarity.

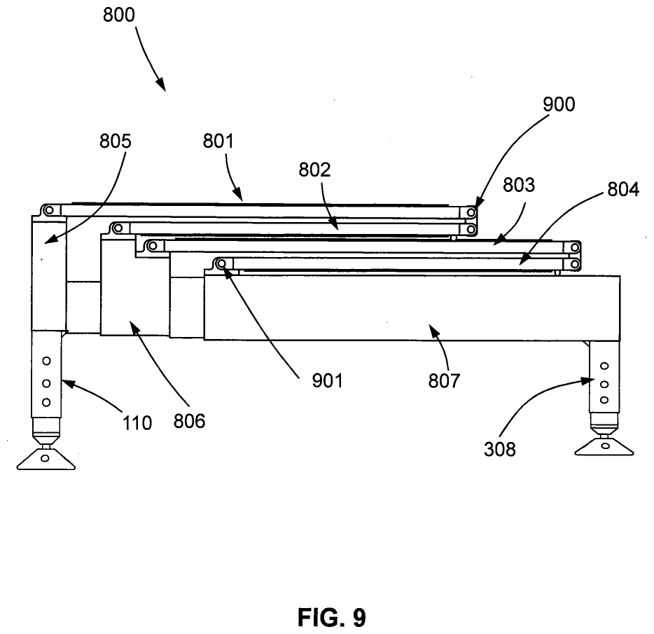

Referring to FIG. 9, the folding solar panel arrangement 800 is shown in the fully collapsed and stacked configuration. Folding solar panels 801 through 804 are shown generally stacked on one another as the folded and hinged 808 through 811 solar panels 801 through 804 pivot during closure. A plurality of pins 900 and 901 are used at hinge locations 808 through 811 connecting axial projections from each panel. Subframes 805 through 807 show the axially oriented encapsulation of each subframe into the adjacent member.

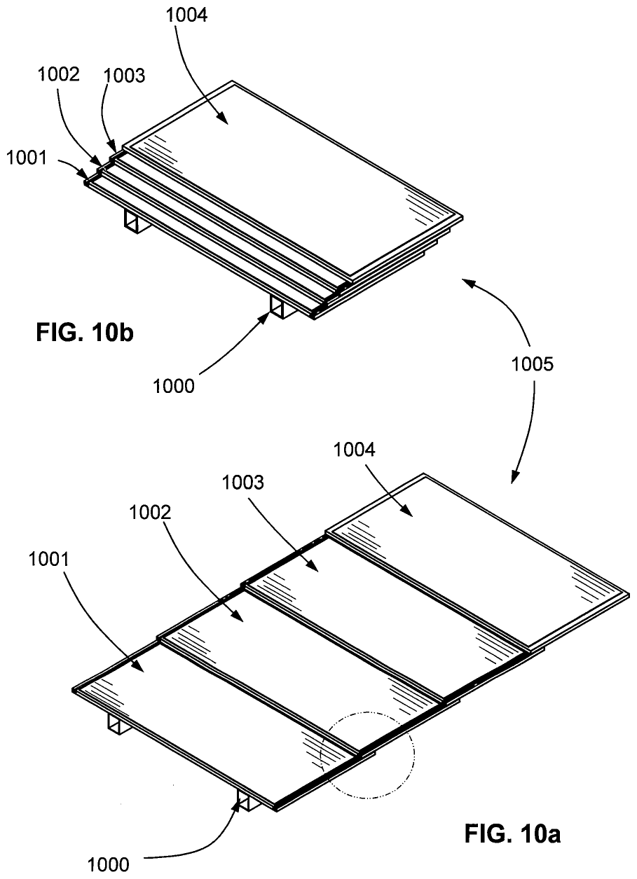

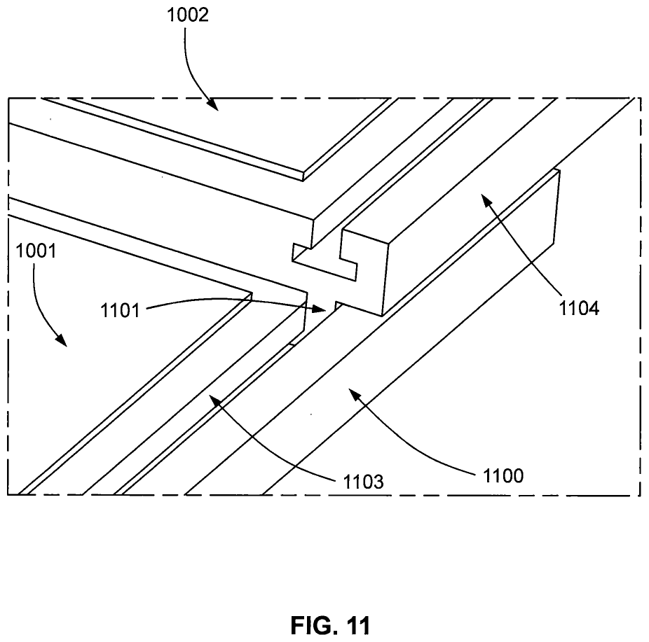

In a further embodiment FIG. 10a, consists of a sliding solar panel arrangement 1005 using a telescoping subframe 1000 construction. Solar panel frames 1001 through 1004 are slid axially relative to one another with “T-shaped” retainment feature 1101 between one another as shown in FIG. 11. Referring to FIG. 10b showing the axially collapsed sliding solar panel arrangement consisting of panels 1001 through 1004 with interlocking elements along the transverse sides.

Referring to FIG. 11, a three-dimensional composite view of sliding rail groove 1100 and 1103. Male sliding element 1101 engages with female groove 1103 allowing for axial extension and collapsing of the solar panel arrangement 1005. Furthermore, solar panels 1001 and 1002, for example, are semi-permanently or permanently affixed to subframe members 1100 and 1104 respectively. Sliding frame members 1100 and 1004, for example, would be made of aluminum or thin stainless steel fabrications.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Notwithstanding, the various assembly and mechanical deployment and stabilization techniques, as they relate to the solar array structure, are in no way intended to be limiting and merely illustrate various embodiments. The primary invention, and various alternative embodiments, has been described above, and it is understood that many modifications, substitutions and additions may be made which are within the intended spirit and scope of the invention.

1. A telescoping solar panel frame system for providing photovoltaic power to a sailing vessel comprising: a plurality of photovoltaic solar panels arranged generally horizontally and mutually parallel to one another; a telescoping base frame structure to support said panels consisting of at least two sliding sections, nested one within the other, to enable extension and retraction of the base frame structure; wherein said base frame structure has a male-female sliding fit between the rectangular or circular tube sliding sections; wherein each sliding base frame section can be locked into position with spring pin locks; wherein the aftmost and forwardmost base frame sections have vertically downward projecting adjustable legs; wherein flexible or rigid photovoltaic solar panels are attached, permanently or semi-permanently, to lightweight rigid solar panel frames; wherein the solar panel frames abut each other along the panel frame longitudinal edge; wherein the forwardmost edge of each panel frame connects to a sliding subframe member with at least two hold-down members that are permanently affixed to the subframe member; wherein hold-downs consist of an axial overhanging feature that captures the forward edge of the solar panel frame; wherein the aft portion of each solar panel frame is captured by a spring pin lock mechanism; wherein the aft edge of each solar panel frame has aft facing projections that allow for spring pin engagement to hold the panel frame in place; wherein solar panel frames can easily be installed and removed for deployment and storage using the overhanging and pining methods; wherein the base frame structure can be axially collapsed for storage on the foredeck after removal of solar panel frames; wherein an electrical connection wire, is attached to each solar panel and terminates at a fixed power connection to the top deck or continues to a solar charge controller and power battery bank using an extension wire; wherein the solar frame system is generally placed on the sailing vessel foredeck between the vessel mast and bow, or forwardmost part of the sailing vessel, and perpendicular to the sailing vessel forward to aft centerline; wherein the base frame structure is permanently or semi-permanently affixed to the foredeck.

2. A telescoping solar array system as in claim 1, wherein the base frame structure members are made from thin-walled stainless steel tubing or composite tubing of rectangular or circular cross-section.

3. A telescoping solar array as in claim 1, wherein the vertical legs have a female tubular member permanently affixed to the subframe; wherein the female vertical legs encompass a male vertical member forming a sliding fit for adjustability; wherein the male-female fit legs can be locked into various vertical positions using a spring pin assembly; wherein the male vertical leg member has a base foot that is attached through a swivel joint to allow for various foredeck geometries; wherein the forward leg base feet can be permanently or semi-permanently attached to the foredeck.

4. A telescoping solar array as in claim 1, with vertically downward facing legs at the far corners; wherein the legs use a screw-in male member for height adjustment.

5. A telescoping solar array as in claim 1, with vertically downward facing legs at the far corners; wherein the legs have an attached base foot member that is rigidly fixed to the vertically adjustable leg member.

6. A telescoping solar array as in claim 1, with application for using on a travel trailer, motor boat or automobile top.

7. A telescoping and folding solar panel frame system for providing photovoltaic power to a sailing vessel comprising: a plurality of photovoltaic solar panels arranged generally horizontally and mutually parallel to one another; a telescoping base frame structure to support said panels consisting of at least two sliding sections, nested one within the other, to enable extension and retraction of the base frame structure; wherein said base frame structure has a male-female sliding fit between the rectangular or circular tube sliding sections; wherein each sliding base frame section can be locked into position with spring pin locks; wherein the aftmost and forwardmost base frame sections have vertically downward projecting adjustable legs; wherein flexible or rigid photovoltaic solar panels are attached, permanently or semi-permanently, to lightweight ridged solar panel frames; wherein the forwardmost panel frame is attached on the forward longitudinal edge by at least two hinge joints to the forward base frame subassembly; wherein the forwardmost panel frame has the aft longitudinal edge of the adjacent solar panel frame has at least two pinned or hinged joints to the adjacent solar panel frame; wherein the aft longitudinal edge has at least two hinge joint connected to the second adjacent base subframe; wherein the forwardmost two panels form a folding arrangement for storage and deployment; wherein a plurality of similar panel configurations are identical to the first two forwardmost solar panel attachments to the base frame; wherein the plurality of solar panels will fold over one another in the stowed position while axially collapsing the base frame structure; wherein an electrical connection wire, is attached to each solar panel and terminates at a fixed power connection to the top deck or continues to a solar charge controller and power battery bank using an extension wire; wherein the solar frame system is generally placed on the sailing vessel foredeck between the vessel mast and bow, or forwardmost part of the sailing vessel, and perpendicular to the sailing vessel forward to aft centerline; wherein the base frame structure is permanently or semi-permanently affixed to the foredeck.

8. A telescoping solar array system as in claim 7, wherein the base frame structure members are made from thin-walled stainless steel tubing or composite tubing of rectangular or circular cross-section.

9. A telescoping solar array as in claim 7, wherein the vertical legs have a female tubular member permanently affixed to the subframe; wherein the female vertical legs encompass a male vertical member forming a sliding fit for adjustability; wherein the male-female fit legs can be locked into various vertical positions using a spring pin assembly; wherein the male vertical leg member has a base foot that is attached through a swivel joint to allow for various foredeck geometries; wherein the forward leg base feet can be permanently or semi-permanently attached to the foredeck.

10. A telescoping solar array as in claim 7, with vertically downward facing legs at the far corners; wherein the legs use a screw-in male member for height adjustment.

11. A telescoping solar array as in claim 7, with vertically downward facing legs at the far corners; wherein the legs have an attached base foot member that is rigidly fixed to the vertically adjustable leg member.

12. A telescoping solar panel frame system for providing photovoltaic power to a sailing vessel comprising: a plurality of photovoltaic solar panels arranged generally horizontally and mutually parallel to one another; a telescoping base frame structure to support said panels consisting of at least two sliding sections, nested one within the other, to enable extension and retraction of the base frame structure; wherein said base frame structure has a male-female sliding fit between the rectangular or circular tube sliding sections; wherein flexible or rigid photovoltaic solar panels are attached, permanently or semi-permanently, to lightweight rigid solar panel frames; wherein solar panel frames use a “T-shaped” groove oriented along the axial edges that align with the sailboat forward to aft centerline; wherein each corresponding solar panel frame has a companion “T-shaped” downward facing interfacing member that engages with the female groove in the adjacent solar panel frame; wherein the assembled adjacent solar panel frames form a ridged structure while fully deployed in the vessel longitudinal directions; wherein panel frames are connected at one end permanently to the base frame members; wherein the collapsed structure has mating tongue-and-groove rail interface allowing for the vertical stacking of the stowed solar array system; wherein each sliding solar panel frame section can be locked into position with spring pin locks or similar; wherein the aftmost and forwardmost base frame sections have vertically downward projecting adjustable legs; wherein an electrical connection wire, is attached to each solar panel and terminates at a fixed power connection to the top deck or continues to a solar charge controller and power battery bank using an extension wire; wherein the solar frame system is generally placed on the sailing vessel foredeck between the vessel mast and bow, or forwardmost part of the sailing vessel, and perpendicular to the sailing vessel forward to aft centerline; wherein the base frame structure is permanently or semi-permanently affixed to the foredeck.

13. A telescoping and sliding solar array as in claim 12, wherein the vertical legs have a female tubular member permanently affixed to the subframe; wherein the female vertical legs encompass a male vertical member forming a sliding fit for adjustability; wherein the male-female fit legs can be locked into various vertical positions using a spring pin assembly; wherein the male vertical leg member has a base foot that is attached through a swivel joint to allow for various foredeck geometries; wherein the forward leg base feet can be permanently or semi-permanently attached to the foredeck.

14. A telescoping solar array as in claim 12, with vertically downward facing legs at the far corners; wherein the legs use a screw-in male member for height adjustment.

15. A telescoping solar array as in claim 12, with vertically downward facing legs at the far corners; wherein the legs have an attached base foot member that is rigidly fixed to the vertically adjustable leg member.
